(19) United States
(12) Patent Application Publication
(10) Pub. No.: US 2018/0371181 A1
(43) Pub. Date: Dec. 27, 2018

(54) CARBON BLACK LATEX MASTERBATCH COMPOSITION

(71) Applicant: SKI CARBON BLACK (INDIA) PVT LTD, Mumbai (IN)

(72) Inventors: Ranjan Ghosal, Mumbai (IN); Sachin Shelukar, Raigad (IN); Saptarshi Kar, Mumbai (IN); Abhijith Urumise, Thrissir (IN)

(21) Appl. No.: 15/781,237

(22) PCT Filed: Dec. 2, 2016
(86) PCT No.: PCT/IB2016/001846

§ 371 Date: Jun. 4, 2018

(30) Foreign Application Priority Data
Dec. 3, 2015 (IN) 4568MUM/2015

(51) Int. Cl. C08J 3/22; C08L 9/08; C08L 7/02

(52) U.S. Cl. CPC C08J 3/22; C08L 9/08; C08J 2307/02; C08J 2309/08; C08L 7/02

(57) ABSTRACT

A carbon black-latex masterbatch composition that can impart improved properties to a resulting rubber compound, and methods for the preparation and use of the carbon black-latex masterbatch composition.

### FIELD OF INVENTION

This disclosure relates generally to masterbatch compositions, and specifically to masterbatch compositions comprising carbon black and latex, and to methods for making and using the same.

### BACKGROUND

Carbon black is a typical ingredient in rubber compounds due to the unique structural properties it imparts to the compound's elastomeric network; however, obtaining uniform dispersions of carbon black in rubber on an industrial scale can be a challenge, and high shear, high energy mixers are usually needed for this purpose. A continuing interest exists in producing premixed, well dispersed masterbatches of carbon black in rubber, since mixing the masterbatch and additional raw rubber is inherently easier. To be effective, the carbon black in a carbon black-rubber masterbatch must be well dispersed.

Accordingly, there remains a need for improved carbon black-latex masterbatch compositions, and for methods for making and using such carbon black-latex masterbatch compositions. These needs and other needs are satisfied by various aspects of the present disclosure.

### SUMMARY OF THE INVENTION

In accordance with the purposes of the invention, as embodied and broadly described herein, the invention provides an improved carbon black-latex masterbatch composition.

In further aspects, the invention also provides methods for preparing and using improved carbon black-latex masterbatch compositions.

While aspects of the present invention can be described and claimed in a particular statutory class, such as the system statutory class, this is for convenience only, and one of skill in the art would understand that each aspect of the present invention can be described and claimed in any statutory class. Unless otherwise expressly stated, it is no way intended that any method or aspect set forth herein be construed as requiring that its steps be performed in a specific order. Accordingly, where a method claim does not specifically state in the claims or description that the steps are to be limited to a specific order, it is no way intended that an order be inferred in any respect.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE FIGURES

FIG. 1 illustrates a conventional process for the production of carbon black and formation of rubber compounds containing carbon black.

FIG. 2 illustrates the inventive process for preparing a carbon black-latex masterbatch composition, in accordance with various aspects of the present disclosure.

FIG. 3 illustrates a property comparison of masterbatch compounds for Mooney viscosity, TC90, and hardness, in accordance with various aspects of the present disclosure.

FIG. 4 illustrates a property comparison of masterbatch compounds for 300% Modulus, Tensile Strength, and Elongation, in accordance with various aspects of the present disclosure.

FIG. 5 illustrates a property comparison of masterbatch compounds for tan delta at 60° C., Tear Strength, and Dispersion, in accordance with various aspects of the present disclosure.

FIG. 6 illustrates a property comparison of masterbatch compounds for Mooney viscosity, TC90, and hardness, in accordance with various aspects of the present disclosure.

FIG. 7 illustrates a property comparison of masterbatch compounds for 300% Modulus, Tensile Strength, and Elongation, in accordance with various aspects of the present disclosure.

FIG. 8 illustrates a property comparison of masterbatch compounds for tan delta at 60° C., Tear Strength, and Rebound resilience, in accordance with various aspects of the present disclosure.

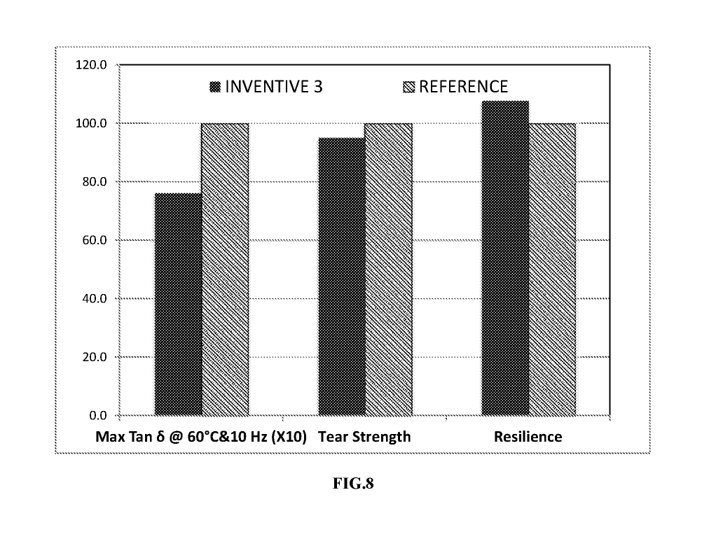

FIG. 9 illustrates a property comparison of masterbatch compounds for Mooney viscosity, TC90, and hardness, in accordance with various aspects of the present disclosure.

FIG. 10 illustrates a property comparison of masterbatch compounds for 300% Modulus, Tensile Strength, and Elongation, in accordance with various aspects of the present disclosure.

FIG. 11 illustrates a property comparison of masterbatch compounds for tan delta at 60° C., Tear Strength, and Rebound resilience, in accordance with various aspects of the present disclosure.

### DETAILED DESCRIPTION

The present invention can be understood more readily by reference to the following detailed description of the invention.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, exemplary methods and materials are now described.

Moreover, it is to be understood that unless expressly stated otherwise, it is in no way intended that any method set forth herein be construed as requiring that its steps be performed in a specific order. Accordingly, where method claim does not actually recite an order to be followed by its steps or it is not otherwise specifically stated in the claims or descriptions that the steps are to be limited to a specific order, it is no way intended that an order be inferred, in any respect.

All publications mentioned herein are incorporated herein by reference to disclose and describe the methods and/or materials in connection with which the publications are cited.

It is also to be understood that the terminology used herein is for the purpose of describing particular aspects only and is not intended to be limiting. As used in the specification and in the claims, the term “comprising” can include the aspects “consisting of” and “consisting essentially of” Unless defined otherwise, all technical and scientific terms used herein have the same meaning as commonly understood by one of ordinary skill in the art to which this invention belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “a lubricant” includes two or more lubricants.

As used herein, the terms “about” and “at or about” mean that the amount or value in question can be the value designated some other value approximately or about the same. It is generally understood, as used herein, that it is the nominal value indicated up to ±10% variation unless otherwise indicated or implied. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance can or cannot occur, and that the description includes instances where said event or circumstance occurs and instances where it does not.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

Disclosed are materials to be used in the preparation of components of the invention, the components of the invention themselves, and methods for the manufacture and use of such components. These and other materials are disclosed herein, and it is understood that when combinations, subsets, interactions, groups, etc. of these materials are disclosed that while specific reference of each various individual and collective combinations and permutation of these materials cannot be explicitly disclosed, each is specifically contemplated and described herein. For example, if a particular component is disclosed and discussed and a number of modifications that can be made to a number of materials including the components are discussed, specifically contemplated is each and every combination and permutation of the components and the modifications that are possible unless specifically indicated to the contrary. Thus, if a class of materials A, B, and C are disclosed as well as a class of materials D, E, and F and an example of a combination materials, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific aspect or combination of aspects of the methods of the invention.

As used herein, the term or phrase “sufficient,” “sufficient amount,” or “conditions sufficient to” refers to such amount or condition that is capable of performing the function or property for which a sufficient amount or condition is expressed. As will be pointed out below, the exact amount or particular condition required can vary from one aspect to another, depending on recognized variables such as the materials employed and the processing conditions observed; however, it should be understood that an appropriate effective amount or condition could be readily determined by one of ordinary skill in the art in possession of this disclosure using only routine experimentation.

As used herein, unless specifically stated to the contrary, the abbreviation “phr” is intended to refer to parts per hundred of rubber, as is typically used in the rubber industry to describe the relative amount of each ingredient in a composition.

Various analytical tests and values are recited herein to describe in-rubber properties of a rubber compound. Such tests and/or values are intended to refer to those tests and procedures typically used in the respective industry (e.g., rubber compounding and/or tire manufacture), or used as standard test procedures, such as, for example, ASTM D3192-09.

It is understood that the compositions disclosed herein have certain functions. Disclosed herein are certain requirements for performing the disclosed functions and it is understood that there are a variety of embodiments that can perform the same function that are related to the disclosed compositions, and that these compositions will typically achieve the same result.

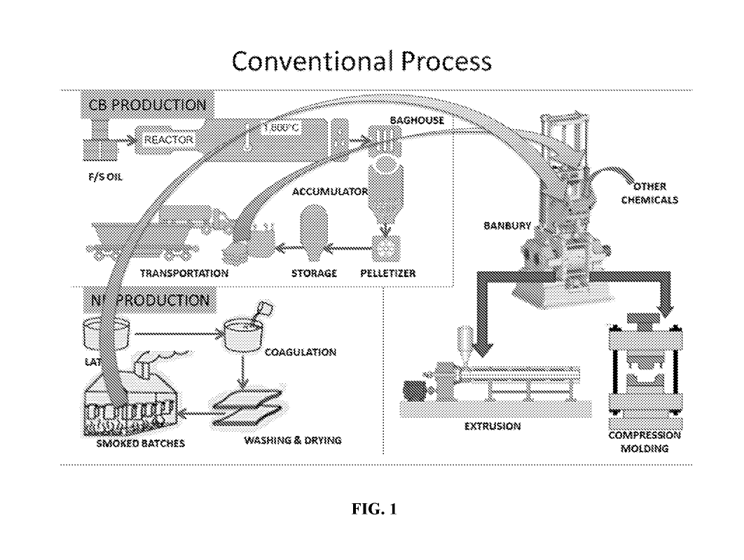

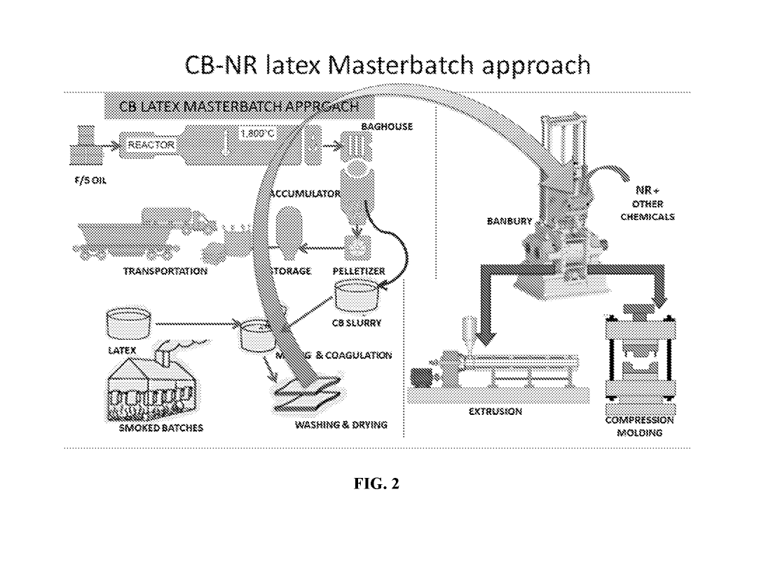

As briefly described above, conventional rubber compounding includes the separate addition of carbon black and elastomer to a mixer, such as a Banbury, as illustrated in FIG. 1. Carbon black materials are inherently difficult to disperse, particularly in elastomeric systems. Accordingly, there is a need to produce masterbatch compositions containing well-dispersed carbon black. These masterbatch compositions can then be introduced into a mixer and let-down or diluted with additional elastomer of the same or varying type, to produce a desired rubber compound, as illustrated in FIG. 2.

In one aspect, the principal object of the present invention is to provide a novel masterbatch of carbon black and raw latex. One of the methods for producing a masterbatch of carbon black in rubber is to mix an aqueous dispersion of carbon black with raw liquid latex. The mixture is coagulated to obtain a well dispersed masterbatch of rubber latex and carbon black. Used as an ingredient in a rubber compound formulation, this can facilitate efficient dispersion of carbon black into rubber, with lower energy of mixing in industrial scale rubber compounding processes.

In one aspect, the inventive masterbatch composition can impart improved properties to a rubber compound, such as, for example, tan δ, tensile strength, and/or modulus. In another aspect, the inventive masterbatch composition can reduce and/or eliminate the need for high energy processing steps for an end user. In another aspect, the present invention can improve the ease with which rubber processors disperse carbon black in a compound. In yet another aspect, the present invention can improve the quality of rubber compounds containing carbon black. In still another aspect, the present invention can minimize and/or eliminate the requirement for pelletization of carbon black.

While carbon black-latex masterbatch compositions have been produced before, they usually suffer from poor dispersion of carbon black, intensive process configurations (including high energy mixing), and inefficient coagulation techniques for the carbon black-raw latex dispersion.

In one aspect, the present disclosure provides methods for the production of a masterbatch of raw rubber latex together with a carbon black. In various aspects, such technology can improve the mixing of carbon black with rubber, reduce processing costs for the manufacture of rubber goods, and provide improved properties to a resulting rubber compound. In another aspect, the technology of the present disclosure can also allow a carbon black manufacturer to reduce and/or eliminate traditional pelletization steps in the manufacturing process.

In various aspects, the present invention provides contacting natural rubber latex and a carbon black-water dispersion to obtain a homogeneous carbon black-latex masterbatch. Physical properties of rubber vulcanizates prepared with the inventive masterbatch composition showed improved performance compared to conventional rubber compounds of the same composition.

The steps involved in preparing a carbon-black rubber masterbatch can include 1) obtaining and/or preparing a well-dispersed slurry of carbon black in water 2) mixing the slurry with liquid latex, and 3) coagulating the slurry-latex mixture and dewatering it efficiently to obtain a solid masterbatch. Since the viscosity of the carbon black-water dispersion is an important key parameter in determining the quality of the final masterbatch, the inventive methods include the use of one or more surfactants to enhance the dispersion of carbon black in water. In addition, coagulation of the mixture can be optimized by varying the pH and temperature of the mixture.

In various aspects, the invention comprises preparation of an aqueous dispersion of carbon black. The carbon black of the present invention can comprise any suitable carbon black for preparing a masterbatch with a natural rubber latex. In one aspect, the carbon black comprises a carbon black produced by the furnace process. In another aspect, the carbon black comprises a rubber grade carbon black or a carbon black suitable for compounding into an elastomer system. In another aspect, the carbon black comprises an ASTM grade carbon black suitable for use in a rubber compound. In another aspect, the carbon black can comprise a mixture of one or more carbon blacks having similar or differing colloidal properties. In yet another aspect, the carbon black can comprise a tread grade carbon black and/or a carcass grade carbon black. In yet another aspect, the carbon black can comprise a pelletized or an unpelletized (i.e., powdered) carbon black. In yet another aspect, the carbon black can comprise a N234 grade carbon black. In various aspects, the carbon black comprises an N234 grade carbon black, available from SKI Carbon Black (India) Pvt Ltd, Aditya Birla Centre, S. K. Ahire Marg, Worli, Mumbai—400030, Maharashtra, India. In one aspect, the aqueous dispersion of carbon black is a stable, aqueous dispersion. In another aspect, the dispersion comprises an unpelleted or powdered carbon black. In another aspect, the aqueous dispersion comprises one or more surfactants. The dispersion can be prepared using any mixing equipment available to one of skill in the art and suitable for use in dispersing carbon black. The surfactant can comprise any surfactant suitable for use with carbon black and latex materials. The concentration of carbon black in an aqueous slurry can vary depending upon, for example, the particular grade of carbon black and the desired properties of the resulting rubber masterbatch or final rubber product. In various aspects, the carbon black concentration in an aqueous slurry can be from less than about 1 wt. %, to about 3 wt. %, to greater than about 5 wt. %, from about 10 wt. % to about 15 wt. %, or higher. In other aspects, the carbon black concentration in an aqueous slurry can be at least about 5 wt. %, at least about 6 wt. %, at least about 7 wt. %, at least about 8 wt. %, at least about 10 wt. %, at least about 12 wt. %, at least about 14 wt. %, or higher. In yet another aspect, the carbon black concentration in an aqueous slurry can range from about 5-8 wt. %, from about 5-10 wt. %, from about 7-12 wt. %, from about 7-15 wt. %, or from about 5 wt. % to about 15 wt. %. It should be understood that any combination of concentrations and/or ranges embodied herein are intended to be covered by the invention, even if not specifically recited. The surfactant of the present invention should be able to stabilize a carbon black slurry and allow the production of a good dispersion. In another aspect, the surfactant should not adversely affect the process of mixing the carbon black slurry with a natural latex solution or composition. In yet another aspect, the surfactant should not adversely affect a subsequent coagulation step. In still another aspect, the surfactant should provide the desired properties and dispersion at low concentrations in water. Thus, the surfactant can comprise any surfactant suitable for use with the present invention. The surfactant can comprise a nonionic surfactant, an ionic surfactant, such as, for example, an anionic surfactant and/or a cationic surfactant, and/or a combination thereof. In one aspect, the surfactant comprises a non-ionic surfactant. In another aspect, the surfactant comprises an anionic surfactant. In various aspects, the surfactant can comprise TERGITOL™ brand surfactant, such as, for example, TERGITOL™ 15 S 30, available from Sigma Aldrich. In yet another aspect, the surfactant can comprise TAMOL™ brand surfactant, such as, for example, TAMOL™ NN9104, available from BASF. In other aspects, the surfactant can comprise one or more surfactants not specifically recited herein.

In another aspect, the invention comprises preparation of a rubber composition, such as, for example, a stabilized natural rubber latex. The methods of the present invention can also be used with other rubber materials, such as, for example, a synthetic latex, a styrene-butadiene rubber, or other rubber materials commonly used in the manufactured rubber goods and tire industries. It should be appreciated that any recitation herein regarding a natural rubber latex is also intended to include aspects where one or more other rubber materials are used in addition to or in lieu of the recited natural rubber latex. It should also be appreciated that the use of other rubber materials can require modifications to the mixing times, ratios, etc., but one of ordinary skill in the art would readily be able to make such modifications in view of the teachings of this disclosure. In one aspect, the natural rubber latex of the present invention can comprise a 60% natural rubber latex, for example, 60% Cenex, available from Harrison Malayalam Limited 24/624, Bristow Road, Willingdon Island, Cochin 682003, Kerala, India.

In still another aspect, the invention comprises contacting, such as, for example, mixing, the aqueous carbon black dispersion and the stabilized natural rubber latex. In one aspect, contacting comprises mixing the two phases (aqueous carbon black dispersion and natural rubber latex) so as to form a stable carbon black-latex dispersion.

In yet another aspect, the invention comprises coagulation by, for example, various means, to recover a portion of the solid components of the mixture as a homogeneous phase of rubber and carbon black. In one aspect, the coagulation is a controlled coagulation of the masterbatch composition and can occur either with or without the use of a chemical agent. Such a controlled coagulation can facilitate the separation of serum and rubber components.

In one aspect, the present invention comprises preparation of a stable aqueous dispersion of unpelleted carbon black with the help of surfactants and mixing equipment, preparation of stabilized natural rubber latex, mixing of the two phases to develop a stable carbon black-latex dispersion, and coagulation by various means to recover most of the solid components of the mixture as a homogeneous phase of rubber and carbon black.

In another aspect, a homogeneous or substantially homogeneous aqueous slurry of carbon black can be prepared using water, one or more surfactants, and an unpelletized carbon black. In one aspect, a mixture of the aqueous slurry of carbon black and natural rubber latex, such as, for example, an alkali-NR latex, can be coagulated using an acid, after which the coagulated product can be separated by, for example, filtration, and then optionally be dried. In another aspect, a mixture of the aqueous slurry of carbon black and natural rubber latex can be coagulated using heat treatment, after which the coagulated product can be separated by, for example, filtration, and then optionally be dried. In other aspects, other coagulation agents known and/or used in the rubber industry can be utilized in addition to or instead of an acid.

In another aspect, the present disclosure provides utilizes chemical stabilization methods to improve the uniformity of a carbon black-latex masterbatch, as well as novel methods to coagulate the masterbatch with improved efficiency.

In one aspect, the carbon black content of a resulting masterbatch composition can be determined by, for example, thermogravimetric analysis.

In another aspect, the present invention and the methods described herein can be performed without the need for high energy mixers, such as those traditionally used to disperse carbon blacks into rubber materials. In another aspect, the present invention facilitates a reduction or elimination of chemicals typically used in the dispersion and masterbatch manufacturing process. In another aspect, the inventive carbon black-latex masterbatch composition can provide improved compound properties over conventional rubber-carbon black mixing techniques and compositions.

The carbon black-latex masterbatch composition of the present invention can be useful in the rubber products industry, including, for example, tires, manufactured rubber goods (MRG), and specialty rubber applications.

In another aspect, the methods and compositions of the present invention illustrate that a concentrated carbon black-latex masterbatch (e.g., >65 phr carbon black) can provide improved properties over a conventional compound.

In one aspect, the methods of the present invention can provide a natural rubber latex-carbon black masterbatch using an acid. In another aspect, the methods of the present invention can provide a natural rubber latex-carbon black masterbatch without the use of an acid for coagulation.

In one aspect, a natural rubber latex carbon black masterbatch can be prepared, followed by coagulation with an acid, such as, for example, formic acid, citric acid, acetic acid, or sulfuric acid. In one aspect, the acid can comprise an organic acid. In another aspect, the acid can comprise an inorganic acid. In a specific aspect, the acid comprises formic acid. It should be understood that any acid suitable for use in coagulating rubber compounds can be used, and any recitation herein describing an acid, such as formic acid, is intended to include aspects, wherein other aspects are used in addition to or in lieu of the recited acid. In such an aspect, a natural rubber latex solution can be prepared separate from the preparation of a carbon black slurry. The natural rubber latex solution and the carbon black slurry can then be contacted, for example, mixed. The mixed composition can then be coagulated and dried to form a masterbatch composition. The concentration of acid utilized to coagulate a rubber solution and carbon black slurry can vary, and one of ordinary skill in the art, in possession of this disclosure, could readily determine an appropriate amount of acid to use for a coagulation process.

In one aspect, a natural rubber latex solution can be prepared by contacting a quantity of, for example, 60% natural rubber latex, such as, 60% Cenex, available from Harrison Malayalam Limited, with a sufficient quantity of water to dilute the natural rubber latex to a concentration of about 30%. The diluted natural rubber latex solution can be stirred, for example, continuously using an overhead stirrer, for a period of time. The container holding the diluted and stirred natural rubber latex solution can optionally be covered and/or sealed until later used.

In such an aspect, a carbon black slurry can also be prepared using, for example, a static mixer setup, whereby the carbon black is gradually added at a predefined time interval. The mixer can be any mixer suitable for use in preparing a carbon black slurry and need not be a high shear force mixer. In one aspect, the mixer can comprise a diaphragm pump to circulate added materials. A quantity of surfactant, for example, TERGITOL™ brand surfactant (for example, TERGITOL™ 15 S 30, available from Sigma Aldrich), can be added to demineralized water. Both the surfactant and the carbon black can be divided into a plurality of smaller portions of the same or varying size for charging the mixer. For example, the surfactant can be divided into two portions and the carbon black can be divided into about 8 portions.

An initial quantity of surfactant can be added to the feed hopper of the mixer, wherein the solution is allowed to run through the mixer. Portions of carbon black and surfactant can be added in, for example, an alternating fashion, until all of the components have been contacted. This process can be repeated as needed to utilize all of the carbon black and surfactant solution. After addition of the last portions of the components, the last mixing step can be run for a longer period of time, for example, about ten minutes instead of three minutes. It should be noted that the specific times for an individual mixing step can vary. In one aspect, the components can be mixed for a longer period of time after all of the components have been incorporated or added to the mixer. The carbon black slurry can then be discharged in to a vessel. Additional surfactant solution, as a rinse, can be added to the mixer and run. This portion of surfactant solution can be discharged into the vessel containing the carbon black. In one aspect, the carbon black slurry so prepared can be stirred, for example, continuously, until used or for a period of about 5 minutes.

The natural rubber latex solution and carbon black slurry can then be contacted. In one aspect, the natural rubber latex solution and the carbon black slurry can be mixed by simultaneously adding the two components in concurrent fashion to a vessel, while stirring, for example, continuously, at about 600 rpm.

The mixture of natural rubber latex solution and carbon black slurry can be coagulated by preparing a 7% formic acid solution (e.g., about 6,000 ml) and adding the formic acid solution to the natural rubber latex/carbon black mixture gradually over a period of, for example, about 15 minutes. The resulting combination can then be left undisturbed for a period of about 2 hours, after which it can be filtered. The mixture can then be transferred to steel trays and dried by placing in an oven at 70° C. for about 5.5 hours or dried using any other means such as passing through heated rollers, a UV light source, or a continuous mixer with heating. The operator can then sheet out the dried masterbatch by passing through a two roll mill. The moisture content of the resulting material should be less than about 1 wt. %.

In another aspect, a natural rubber latex carbon black masterbatch can be prepared, followed by coagulation at elevated temperature, such as, for example, heating to about 70° C. for a period of from about 4 to about 8 hours. In such an example, a natural rubber latex solution can be prepared separate from the preparation of a carbon black slurry. The natural rubber latex solution and the carbon black slurry can then be contacted, for example, mixed. The mixed composition can then be coagulated and dried to form a masterbatch composition.

In another aspect, the natural rubber latex solution can be prepared by contacting a quantity of natural rubber latex with water and an antioxidant, such as, for example, a powdered antioxidant suitable for use with rubber compounds. The antioxidant, if present, can comprise any suitable antioxidant for use with rubber materials. Similarly, the concentration and amount of antioxidant can vary, depending upon, for example, the specific rubber material and specific antioxidant utilized, and one of ordinary skill in the art, in possession of this disclosure, could readily determine an appropriate concentration of a given antioxidant to use. In one aspect, an antioxidant can be useful when the resulting mixture is coagulated using an elevated temperature.

The mixture of natural rubber latex solution and carbon black slurry can be coagulated by filtering the mixture of natural rubber latex and carbon black using a filter and squeezing to remove excess water. The mixture can then be transferred to steel trays. The mixture can be coagulated and dried by placing it in an oven at about 70° C. for a period of about 8 hours. The mixture can then be sheeted out by passing it through a two roll mill. The moisture content of the resulting material should be less than about 1 wt. %.

Thus, in various aspects, the methods of the present invention can provide a masterbatch having a carbon black loading of greater than about 50 phr, for example, about 50 phr, 55 phr, 60 phr, 65 phr, or more. In one aspect, the methods of the present invention can provide a masterbatch having a carbon black loading of from about 20 phr to about 80 phr carbon black, for example, about 20, 25, 30, 35, 40, 45, 50, 55, 60, 65, 70, 75, or 80 phr carbon black. In another aspect, the methods of the present invention can provide a masterbatch having a carbon black loading of from about 35 phr to about 75 phr carbon black, for example, about 35, 40, 45, 50, 55, 60, 65, 70, or 75 phr carbon black. In another aspect, the methods of the present invention can provide a masterbatch having a carbon black loading of from about 45 phr to about 65 phr carbon black, for example, about 45, 46, 47, 48, 49, 50, 51, 52, 53, 54, 55, 56, 57, 58, 59, 60, 61, 62, 63, 64, or 65 phr carbon black. It should be appreciated that concentration or any components recited in any of the methods described herein can be adjusted to provide a desired carbon black loading in the masterbatch.

Any of the inventive masterbatch compositions described herein can be utilized in the preparation of a rubber compound. In one aspect, the inventive masterbatch can be compounded according to ASTM D3192-09 (2014) by, for example, diluting with CV60 to bring the carbon black PHR to 50. When compared against a reference preparing by mixing pelleted ASTM N234 grade carbon black in CV60 using the conventional ASTM D3192-09 recipe, mixing time for the inventive masterbatch can be significantly reduced due to the improved carbon black dispersion. The inventive masterbatch compositions can also be let-down or diluted with one or more rubber compositions (e.g., synthetic rubber latex, styrene butadiene rubber) to produce a final rubber compound.

As noted above, the methods described herein and the inventive masterbatch compositions can impart one or more improved properties to a rubber compound, as compared to a conventional rubber compounding mix using either no masterbatch or a masterbatch having a lower phr loading of carbon black, for example, when compounded using conventional techniques (e.g, ASTM D3192). In one aspect, at least one of the rubber properties described below is improved. In another aspect, at least two of the rubber properties described below are improved. In yet another aspect, at least three of the rubber properties described below are improved. In still other aspects, at least four, five, or six of the rubber properties described below are improved.

In one aspect, use of the inventive methods and/or masterbatch can impart a decrease in Mooney Viscosity of from about 5% to about 25%, for example, about 5, 6, 7, 8, 9, 10, 11, 12, 13, 14, 15, 16, 17, 18, 19, 20, or 25%; from about 5% to about 10%, from about 8% to about 20%, or from about 9% to about 25% in a rubber compound prepared using the inventive masterbatch. In another aspect, use of the inventive methods and/or masterbatch can impart an increase in the 300% Modulus of a rubber compound prepared using the inventive masterbatch of from about 4% to about 40%, for example, about 4, 5, 10, 12, 14, 16, 18, 20, 22, 24, 26, 28, 30, 32, 34, 35, 36, 37, 38, 39, or 40%; from about 15% to about 30%, from about 5% to about 25%, from about 18% to about 35%; or from about 17% to about 26%. In yet another aspect, use of the inventive methods and/or masterbatch can impart an increase in the Tensile Strength of a rubber compound prepared using the inventive masterbatch of from about 20% to about 45%, for example, about 20, 25, 30, 35, 40, or 45%; from about 20% to about 35%, from about 25% to about 40%, from about 30% to about 45%, or from about 25% to about 40%. In yet another aspect, use of the inventive methods and/or masterbatch can result in no or substantially no change (i.e., comparable performance) in the Elongation at break of a rubber compound prepared using the inventive masterbatch.

In yet another aspect, use of the inventive methods and/or masterbatch can impart an increase in the Tear Strength of a rubber compound prepared using the inventive masterbatch of from about 15% to about 30%, for example, about 15, 20, 25, or 30%; from about 18% to about 30%, from about 15% to about 25%, from about 20% to about 30%, or from about 17% to about 28%. In yet another aspect, use of the inventive methods and/or masterbatch can impart a decrease in the tan delta @ 60° C. (10 Hz) of a rubber compound prepared using the inventive masterbatch of from about 5% to about 35%, for example, about 5, 10, 15, 20, 25, 30, or 35%; from about 5% to about 30%, from about 10% to about 15%, from about 10% to about 25%, or from about 7% to about 21%. In still another aspect, use of the inventive methods and/or masterbatch can impart an increase in the Rebound resilience of a rubber compound prepared using the inventive masterbatch of from about 5% to about 15%, for example, about 5, 6, 7, 8, 9, 10, 11, 12, 13, 14, or 15%; from about 5% to about 12%, from about 8% to about 15%, from about 7% to about 12%, or from about 10% to about 15%.

In still other aspects, the inventive methods and masterbatch compositions described herein can provide similar or improved hardness and/or levels of dispersion of carbon black in the resulting rubber compound, as compared to a conventional reference rubber compound. In yet another aspect, the inventive methods and masterbatch compositions described herein can facilitate easier compounding, using less energy, and with potentially faster cure times, such as, for example, from about 25% to about 80%, for example, about 25, 30, 35, 40, 45, 50, 55, 60, 65, 70, 75, or 80% faster cure time; from about 30% to about 65% faster cure time; from about 30% to about 50% faster cure time; or from about 40% to about 65% faster cure time, as compared to a conventional reference rubber compound.

### EXAMPLES

It should be understood that the examples provided herein are only intended to be exemplary embodiments of the present invention, and are not intended to be limiting.

### Example 1—Preparation of Carbon Black-Rubber Masterbatch

In a first example, slurries with a 3% loading of N234 carbon black in water were prepared using a mixer to prepare a a high phr carbon black coagulated masterbatch. The coagulation process, via addition of acetic acid, was optimized to maximize the yield of carbon black masterbatch. Thermogravimetric Analysis (ASTM D6370, using a TA instruments SDT Q600) was used to determine the loading of carbon black in the coagulated latex. A recipe based on ASTM D3192 (Table 2) was used to prepare compounds for testing of rubber properties. Two sets of Reference compounds were prepared using a commercial ASTM N234 grade carbon black loaded in natural rubber at 50 phr, 1) mixed in a Banbury mixer, with final compound sheet-out on a two roll mill, 2) with mixing carried out entirely on a two roll mill. The masterbatch compound was prepared by diluting the masterbatch with raw natural rubber to a level of 50 phr carbon black loading in the final compound, and mixing on a two roll mill with curing additives.

TABLE 1
ASTM D 3192 Rubber Compound Recipe

Quantity, Parts by mass

| Material | Reference | Masterbatch |
|---|---|---|
| Natural rubber | 100.00 | 26.00 |
| Masterbatch | — | 124.00 |
| Stearic acid | 3.00 | 3.00 |
| Zinc oxide | 5.00 | 5.00 |
| Benzothiazyl disulfide | 0.60 | 0.60 |
| Sulfur | 2.50 | 2.50 |
| Carbon black | 50.00 | — |
| Total | 161.10 | 161.10 |

The rubber compounds were evaluated for Mooney viscosity and scorch (ASTM D1646 using an Alfa Technologies MV2000), curing characteristics (ASTM D5289 using an Alfa Technologies RPA2000), tensile properties (ASTM D 412) and tear properties (ASTM D624) using an Instron 3365 tensile tester, hardness (ASTM D2240) using a Wallace H17A/PC hardness tester, and post-cure dynamic properties (ASTM D6601) using an Alfa Technologies RPA 2000.

Table 2 illustrates property comparisons between a reference compound and the inventive compound prepared using the concentrated carbon black-rubber masterbatch. Thermogravimetric Analysis revealed that 66 phr of carbon black was incorporated into the masterbatch, the rest being accounted for by losses from the system.

TABLE 2
Comparison of Rubber properties for a conventionally mixed rubber
compound, and compound prepared with masterbatch

| Property | Latex-CB | |
|---|---|---|
| (UOM) | Masterbatch | Reference |
| TS2 (min) | 0.44 | 1.15 |
| TC90 (min) | 3.13 | 8.54 |
| Tan δ (indicative) | 0.13 | 0.2 |
| Mooney (MU) | 65 | 86 |
| Dispersion (%) | 98 | 95 |
| Modulus @ 100% Elong (MPa) | 4.4 | 3.2 |
| Modulus @ 300% Elong (MPa) | 20.8 | 15.9 |
| Tensile Strength (MPa) | 26.5 | 21.6 |
| Elongation at break (%) | 373 | 378 |
| Hardness (Sh-A) | 70 | 67 |
| Tear Strength (N/mm) | 91.6 | 74.2 |

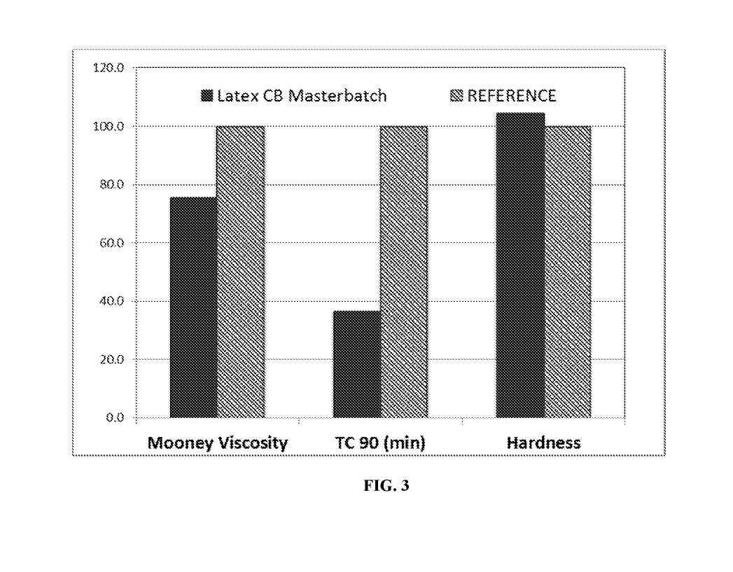

The rubber properties for the compound prepared with the inventive masterbatch exhibited lower Mooney viscosity, faster curing (TC 90), and comparable hardness to the reference compound, as illustrated in FIG. 3. In this figure, values are normalized against the properties of the reference compound (set at 100%).

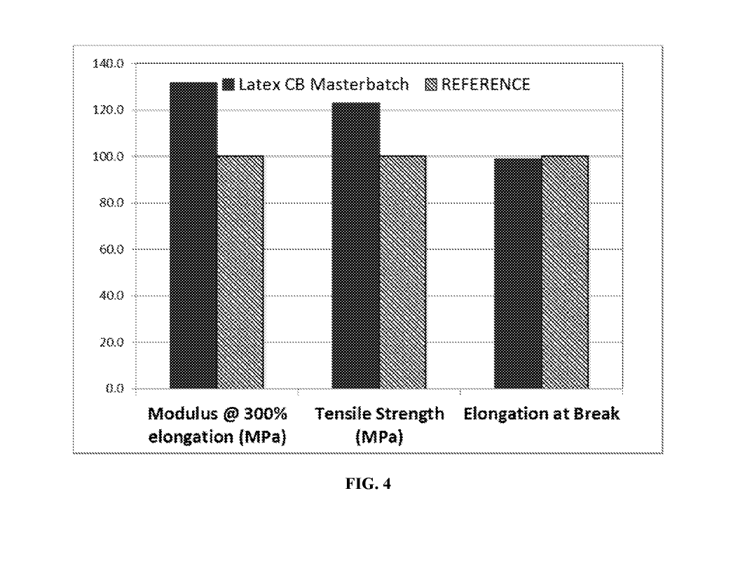

The inventive masterbatch compound also displayed higher modulus at 300% elongation, higher tensile strength and comparable elongation at break, compared to the reference compounds as shown in FIG. 4.

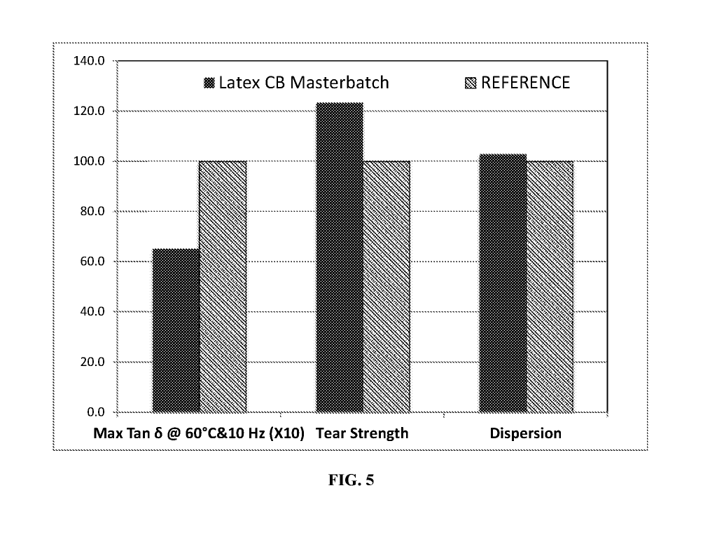

The inventive masterbatch compound also exhibited lower indicative tan δ (@ 60° C. and 10 Hz), higher tear strength and similar dispersion compared to the reference compound, as shown in FIG. 5.

### Example 2—Preparation of Natural Rubber Latex Carbon Black Masterbatch Followed by Coagulation with Formic Acid

In a second example, a natural rubber latex carbon black masterbatch can be prepared, followed by coagulation with formic acid. In such an example, a natural rubber latex solution can be prepared separate from the preparation of a carbon black slurry. The natural rubber latex solution and the carbon black slurry can then be contacted, for example, mixed. The mixed composition can then be coagulated and dried to form a masterbatch composition.

A natural rubber latex solution can be prepared by contacting a quantity, for example, about 1028.5 grams, of 60% natural rubber latex (for example, 60% Cenex, available from Harrison Malayalam Limited) with a sufficient quantity of water to dilute the natural rubber latex to a concentration of about 30%. The diluted natural rubber latex solution can be stirred, for example, continuously using an overhead stirrer, for a period of about 5 minutes at a rate of about 500 rpm. The container holding the diluted and stirred natural rubber latex solution can optionally be covered and/or sealed until later used.

A carbon black slurry can be prepared using, for example, a static mixer setup, whereby the carbon black is gradually added at a predefined time interval. A quantity of surfactant, for example, about 23.15 grams of TERGITOL™ brand surfactant (for example, TERGITOL™ 15 S 30, available from Sigma Aldrich), can be added to about 4.63 liters of demineralized water. Both the surfactant and the carbon black can be divided into a plurality of smaller portions for charging the mixer. For example, the surfactant can be divided into two portions and the carbon black, (e.g., about 463 grams) can be divided into about 8 portions of about 58 grams each.

An initial quantity, for example, about 1600 ml, of surfactant can be added to the feed hopper of the mixer, wherein the solution is allowed to run through the mixer for about 1 minute by opening the compressed air valve. About 58 grams, of carbon black (for example, an ASTM N234 grade carbon black, available from SKI Carbon Black (India) Pvt Ltd, Aditya Birla Centre, S. K. Ahire Marg, Worli, Mumbai—400030, Maharashtra, India, in unpelleted form) can be added, followed by an additional 250 ml of surfactant solution. The combination can be mixed for a period of time, for example, about 3 minutes. At about 5 minutes (since the initial charging), the mixer can be stopped and the next portion (e.g., 58 grams) of carbon black can be added followed by an additional 250 ml of surfactant solution, after which the mixing can be started again and allowed to run for about 3 minutes. This process can be repeated as needed to utilize all of the carbon black and surfactant solution. In one aspect, this process can be repeated six times. The last mixing step can be run for ten minutes instead of the previous three minutes. The carbon black slurry can then be discharged in to a vessel. Additional surfactant solution, for example, about 1,030 ml, can be added to the mixer and run for about 4 minutes. This portion of surfactant solution can be discharged into the vessel containing the carbon black. In one aspect, the carbon black slurry so prepared can be stirred, for example, continuously, until used or for a period of about 5 minutes.

A breakdown of the components and additions are detailed in Table 3, below.

TABLE 3
Steps for the Preparation of a Carbon Black Slurry

| | | | | | Concentration at |
|---|---|---|---|---|---|
| Sl. No. | Water (mL) | CB (g) | t (min) | cum. time | cycle end |
| 1 | 1600.00 | 0.00 | 1.00 | 1.00 | 0.00 |
| 2 | 250.00 | 58.00 | 3.00 | 4.00 | 3.14 |
| 3 | 250.00 | 58.00 | 3.00 | 7.00 | 5.52 |
| 4 | 250.00 | 58.00 | 3.00 | 10.00 | 7.40 |
| 5 | 250.00 | 58.00 | 3.00 | 13.00 | 8.92 |
| 6 | 250.00 | 58.00 | 3.00 | 16.00 | 10.18 |
| 7 | 250.00 | 58.00 | 3.00 | 19.00 | 11.23 |
| 8 | 250.00 | 58.00 | 3.00 | 22.00 | 12.12 |
| 9 | 250.00 | 57.00 | 10.00 | 32.00 | 12.86 |
| | Discharge the CB slurry | | | | |
| 10 | 1030.00 | 0.00 | 4.00 | 36.00 | 10.00 |
| SUM | 4630.00 | 463.00 | 36.00 | 36 | |

The natural rubber latex solution and carbon black slurry can then be contacted. In one aspect, the natural rubber latex solution and the carbon black slurry can be mixed by simultaneously adding the two components in concurrent fashion to a vessel, while stirring, for example, continuously, for about 5 minutes at about 600 rpm.

The mixture of natural rubber latex solution and carbon black slurry can be coagulated by preparing a 7% formic acid solution in 6,000 ml of demineralized water (e.g., 500 ml of 85% formic acid, available from Fisher Scientific, in 6,000 ml water), and adding the 6,000 ml of formic acid solution to the natural rubber latex/carbon black mixture gradually over a period of, for example, about 15 minutes. The resulting combination should then be left undisturbed for a period of about 2 hours, after which it can be filtered using a filter cloth having a specific mesh size suitable for the desired product. Thin sheets of the resulting coagulant can be passed through a two roll mill (e.g., mill parameters, 0.5 mm mill opening, room temperature, gear ratio of 1:1.4). The mixture can then be transferred to steel trays and dried by placing in an oven at 70° C. for about 5.5 hours. The operator can then sheet out the masterbatch by passing through a two roll mill (e.g., mill parameters, 0.5 mm mill opening, room temperature, gear ration of 1:1.4). The moisture content of the resulting material should be less than about 1 wt. %. The resulting material can be stored, for example, inside a zip-lock cover for further processing.

A summary of the mixing conditions, settings, and components is detailed in Table 4, below.

TABLE 4
Summary of Mixing for Natural Rubber Latex and Carbon Black

| VARIABLES | UNIT | INVENTIVE 3 |
|---|---|---|
| Carbon Black | Grams | 463 |
| Water | ml | 4630 |
| Surfactant | — | Tergitol |
| Surfactant (quantity) | Grams | 23.15 |
| Slurry mixing time | Minutes | 36 |
| Latex | Grams | 1028.5 |
| Water | ml | 1028.5 |
| RPM (CB + LATEX MIX) | — | 500 |
| time(CB + LATEX MIX) | Minutes | 10 |
| Formic acid concentration/quantity | — | 6000 ml (7%) |
| (for Coagulation) | | |
| Coagulation time | Minutes | 15 |
| Drying time/temp | Hours | 5.5 hrs. @ 70° c. |
| Moisture content after drying | % | 0.43 |
| Theoretical output | Grams | 1080 |
| Output quantity (actual) | Grams | 1007 |
| CB in masterbatch (Theoretical) | PHR | 75 |
| CB in masterbatch (Actual) | PHR | 63 |

### Example 3—in-Rubber Properties of Natural Rubber Latex Carbon Black Masterbatch

In a third example, the masterbatch prepared in Example 2 was compounded according to ASTM D3192-09 (2014). The masterbatch was diluted using a constant viscosity rubber, such as CV60 (e.g., CLARIMER CV60, available from AkroChem, Akron, Ohio, USA) to bring the carbon black PHR to 50. Rubber properties were compared against a reference preparing by mixing pelleted ASTM N234 grade carbon black in CV60 using the conventional ASTM D3192-09 recipe. Both batches were prepared in a Banbury mixer, followed by sheet out onto a two roll mill. Since the inventive masterbatch already comprised very well dispersed carbon black, the mixing time in the Banbury was significantly reduced.

The in-rubber properties of the inventive masterbatch are detailed in Table 5, below.

TABLE 5
In-Rubber Properties of Inventive Masterbatch

| PROPERTY | UNIT | REFERENCE | INVENTIVE 3 |
|---|---|---|---|
| Mooney viscosity ML | MU | 88.20 | 69 |
| (1 + 4)@ 100° C. | | | |
| Minimum viscosity | MU | 75.00 | 57 |
| T 5 | Minutes | 6.70 | 4.00 |
| T 35 | Minutes | 8.00 | 4.90 |
| Min Torque | dNm | 3.12 | 2.05 |
| Max Torque | dNm | 16.95 | 16.55 |
| TS2 | Minutes | 1.37 | 0.85 |
| T50 | Minutes | 3.03 | 2.03 |
| TC90 | Minutes | 8.39 | 5.61 |
| Dispersion | % | 96.92 | 93.33 |
| Batch Time (Banburry) | Sec | 300 | 180 |
| Batch time (Mill) | Minutes | 8 | 8 |
| M100% | MPa | 2.87 | 2.79 |
| M300% | MPa | 11.92 | 14.00 |
| Tensile strength | MPa | 18.54 | 25.03 |
| Elongation at break | % | 440.00 | 460 |
| Tear strength | N/mm | 80.40 | 76.40 |
| Hardness | IRHD | 69.00 | 67.50 |
| Abrasion loss@ 160/2*tc90 | mm³ | 105.87 | 115.46 |
| Resilience (Curing145/40′) | | 46.60 | 50.20 |
| Heat buildup (Curing 145/60′) | | 21 | — |
| Tan delta@1 HZ, 60° C. | | 0.195 | 0.158 |
| Tan delta@10 HZ, 60° C. | | 0.211 | 0.180 |
| Tan delta@1 HZ, R.T | | 0.1993 | 0.1485 |
| Tan delta@10 HZ, R.T | | 0.2261 | 0.1714 |
| Tan delta@1 HZ, 60° C. | | 0.1399 | 0.1023 |
| Tan delta@10 HZ, 60° C. | | 0.1549 | 0.1180 |

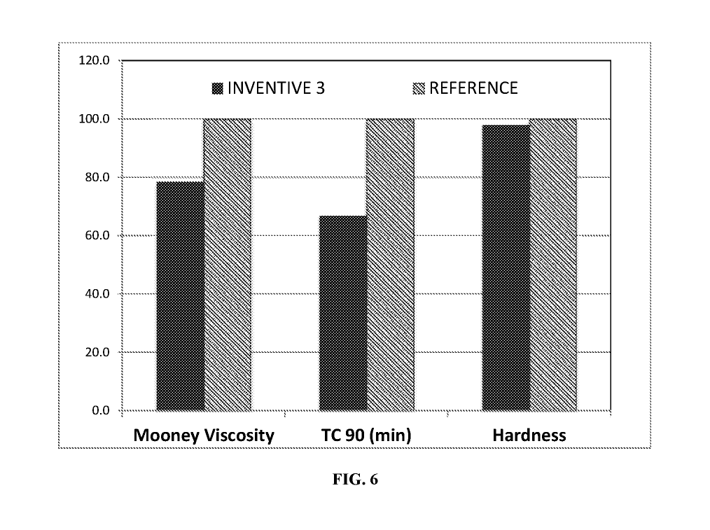

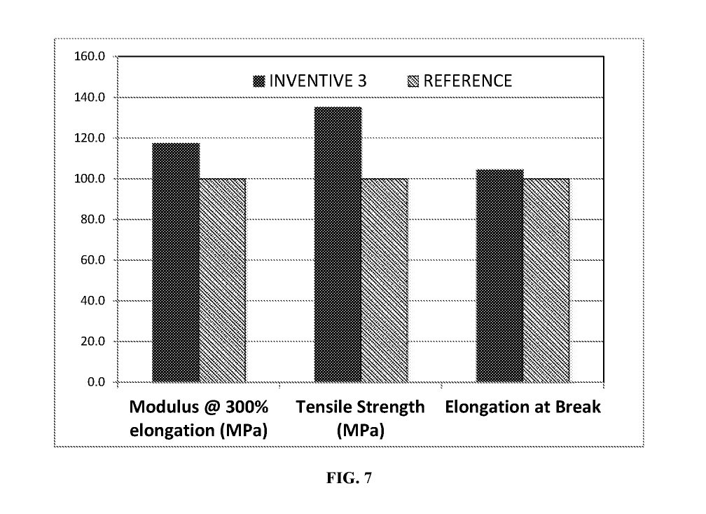

As illustrated in FIG. 6, the INVENTIVE 3 masterbatch imparted a significantly decreased Mooney viscosity, a faster cure time (TC 90) and comparable hardness, as compared to a conventional reference rubber compound. Similarly, the INVENTIVE 3 masterbatch imparted an increased 300% modulus, significantly increased tensile strength, and comparable elongation at break, as compared to a conventional reference rubber compound, as illustrated in FIG. 7. The INVENTIVE 3 masterbatch also resulted in a lower max tan delta @ 60° (10 Hz), comparable tear strength, and increased Rebound resilience, as compared to the conventional reference rubber compound.

### Example 4—Preparation of Natural Rubber Latex Carbon Black Masterbatch Followed by Coagulation with Heating

In a fourth example, a natural rubber latex carbon black masterbatch can be prepared, followed by coagulation with heating. In such an example, a natural rubber latex solution can be prepared separate from the preparation of a carbon black slurry. The natural rubber latex solution and the carbon black slurry can then be contacted, for example, mixed. The mixed composition can then be coagulated and dried to form a masterbatch composition.

A natural rubber latex solution can be prepared by contacting a quantity, for example, about 1028.5 grams, of 60% natural rubber latex (for example, 60% Cenex, available from Harrison Malayalam Limited) with a sufficient quantity of water to dilute the natural rubber latex to a concentration of about 30%. About 6.1 grams of a powdered antioxidant, for example, Antioxidant 4020, available from RDC Chemicals, can also be added to the natural rubber latex solution. The diluted natural rubber latex solution can be stirred, for example, continuously using an overhead stirrer, for a period of about 5 minutes at a rate of about 500 rpm. The container holding the diluted and stirred natural rubber latex solution can optionally be covered and/or sealed until later used.

A carbon black slurry can be prepared using, for example, a static mixer setup, whereby the carbon black is gradually added at a predefined time interval. A quantity of surfactant, for example, about 23.15 grams of TAMOL™ brand surfactant (for example, TAMOL™ NN9104, available from BASF), can be added to about 4.63 liters of demineralized water. Both the surfactant and the carbon black can be divided into a plurality of smaller portions for charging the mixer. For example, the surfactant can be divided into two portions and the carbon black, (e.g., about 463 grams) can be divided into about 2 portions of about 80 grams each, about 3 portions of about 60 grams each, and about 3 portions of about 41 grams each.

An initial quantity, for example, about 1,500 ml, of surfactant can be added to the feed hopper of the mixer, wherein the solution is allowed to run through the mixer for about 1 minute. After about 1 minute, the first portion, for example, about 80 grams, of carbon black (for example, an ASTM N234 grade carbon black, available from SKI Carbon Black (India) Pvt Ltd, Aditya Birla Centre, S. K. Ahire Marg, Worli, Mumbai—400030, Maharashtra, India, in unpelleted form) can be added, followed by an additional 270 ml of surfactant solution. The combination can be mixed by opening the compressed air valve and allowing the mixing to continue for about 3 minutes. At about 5 minutes (since the initial charging), the mixer can be stopped and the next portion (e.g., 80 grams) of carbon black can be added followed by an additional 270 ml of surfactant solution, after which the mixing can be started again and allowed to run for about 3 minutes. This process can be repeated as needed to utilize all of the carbon black (e.g., the three portions of about 60 grams each, followed by the three portions of about 41 grams each) and surfactant solution. The last mixing step can be run for ten minutes instead of the previous three minutes. The carbon black slurry can then be discharged in to a vessel. Additional surfactant solution, for example, about 460 ml, can be added to the mixer and run for about 2 minutes. This portion of surfactant solution can be discharged into the vessel containing the carbon black. This rinse step, of charging the mixer with about 460 ml of surfactant, running for about 2 minutes, and discharging, can optionally be repeated. In one aspect, the carbon black slurry so prepared can be stirred, for example, continuously, until used or for a period of about 5 minutes.

A breakdown of the components and additions are detailed in Table 6, below.

TABLE 6
Steps for the Preparation of a Carbon Black Slurry

| | | | | | Theoretical |
|---|---|---|---|---|---|
| | | | | Cumulative | concentration |
| | Water | CB | Time | time | at cycle end |
| Sl. No. | (ml) | (g) | (min) | (min) | (% . . . CB in water) |
| 1 | 1550.00 | 0.00 | 1.00 | 1.00 | 0.00 |
| 2 | 270.00 | 80.00 | 3.00 | 4.00 | 4.40 |
| 3 | 270.00 | 80.00 | 3.00 | 7.00 | 7.66 |
| 4 | 270.00 | 60.00 | 3.00 | 10.00 | 9.32 |
| 5 | 270.00 | 60.00 | 3.00 | 13.00 | 10.65 |
| 6 | 270.00 | 60.00 | 3.00 | 16.00 | 11.72 |
| 7 | 270.00 | 41.00 | 3.00 | 19.00 | 12.02 |
| 8 | 270.00 | 41.00 | 3.00 | 22.00 | 12.27 |
| 9 | 270.00 | 41.00 | 10.00 | 32.00 | 12.48 |
| | Discharge the CB slurry | | | | |
| | 460.00 | | 2.00 | 34.00 | |
| | 460.00 | | 2.00 | 36.00 | |
| SUM | 4630.00 | 463.00 | 36.00 | | 10.00 |

The natural rubber latex solution and carbon black slurry can then be contacted. In one aspect, the natural rubber latex solution and the carbon black slurry can be mixed by simultaneously adding the two components in concurrent fashion to a vessel, while stirring, for example, continuously, for about 5 minutes at about 600 rpm.

The mixture of natural rubber latex solution and carbon black slurry can be coagulated by filtering the mixture of natural rubber latex and carbon black, and squeezing to remove excess water. The mixture can then be transferred to steel trays. The mixture can be coagulated and dried by placing it in an oven at about 70° C. for a period of about 8 hours. The mixture can then be sheeted out by passing it through a two roll mill (e.g., mill parameters, 0.5 mm mill opening, room temperature, gear ration of 1:1.4. The moisture content of the resulting material should be less than about 1 wt. %. The resulting material can be stored, for example, inside a zip-lock cover for further processing.

A summary of the mixing conditions, settings, and components is detailed in Table 7, below.

TABLE 7
Summary of Mixing for Natural Rubber Latex and Carbon Black

| VARIABLES | UNIT | INVENTIVE 4 |
|---|---|---|
| Carbon Black | Grams | 463 |
| Water | ml | 4630 |
| Surfactant | — | TAMOL |
| Surfactant (quantity) | Grams | 23.15 |
| Slurry mixing time | Minutes | 36 |
| Latex | Grams | 1028.5 |
| Water | ml | 1028.5 |
| Antioxidant 4020 | Grams | 6.1 |
| RPM (CB + LATEX MIX) | — | 500 |
| time(CB + LATEX MIX) | Minutes | 5 |
| Oven temperature for coagulation | degree C. | 70 |
| Drying time/temp | Hours | 8 hrs |
| Moisture content after drying | % | 0.71 |
| Theoretical output | Grams | 1080 |
| Output quantity (actual) | Grams | 938 |
| CB in masterbatch (Theoretical) | PHR | 75 |
| CB in masterbatch (Actual) | PHR | 59 |

### Example 5—in-Rubber Properties of Natural Rubber Latex Carbon Black Masterbatch

In a fifth example, the masterbatch prepared in Example 4 was compounded according to ASTM D3192-09 (2014). The masterbatch was diluted using CV60 to bring the carbon black PHR to 50. Rubber properties were compared against a reference preparing by mixing pelleted ASTM N234 grade carbon black in CV60 using the conventional ASTM D3192-09 recipe. Both batches were prepared in a Banbury mixer, followed by sheet out onto a two roll mill. Since the inventive masterbatch already comprised very well dispersed carbon black, the mixing time in the Banbury was significantly reduced.

The in-rubber properties of the inventive masterbatch are detailed in Table 8, below.

TABLE 8
In-Rubber Properties of Inventive Masterbatch

| PROPERTY | UNIT | REFERENCE | INVENTIVE 4 |
|---|---|---|---|
| Mooney viscosity ML | MU | 88.20 | 81.90 |
| (1 + 4) @ 100° C. | | | |

Mooney properties @ 130° C.

| | | | |
|---|---|---|---|
| Minimum viscosity | MU | 75.00 | 72.00 |
| T 5 | Minutes | 6.70 | 4.80 |
| T 35 | Minutes | 8.00 | 5.80 |

Rheological properties @ 160° C./30 min

| | | | |
|---|---|---|---|
| Min Torque | dNm | 3.12 | 2.74 |
| Max Torque | dNm | 16.95 | 15.34 |
| TS2 | Minutes | 1.37 | 0.86 |
| T50 | Minutes | 3.03 | 1.85 |
| TC90 | Minutes | 8.39 | 5.01 |
| Dispersion | % | 96.92 | 96.12 |
| Batch Time (Banbury) | Sec | 300 | 150 |
| Batch time (Mill) | Minutes | 8 | 5 |

Physical Properties @ 160° C./2*TC 90

| | | |
|---|---|---|
| M100% (MPa) | 2.87 | 2.71 |
| M300% (MPa) | 11.92 | 12.51 |
| Tensile Strength (MPa) | 18.54 | 25.42 |
| Elongation at Break (%) | 440.00 | 449.50 |
| Tear strength (N/mm)) | 80.40 | 98.30 |
| Hardness (IRHD) | 69.00 | 69.00 |
| Abrasion loss@ 160/2*tc90 | 105.87 | 123.44 |
| Resilience (Curing145/40′) | 46.60 | 51.80 |
| Heat buildup (Curing | 21 | 16.5 |
| 145/60′) | | |

Dynamic Properties using RPA

| | | |
|---|---|---|
| Tan delta@1 HZ, 60° C. | 0.195 | 0.159 |
| Tan delta@10 HZ, 60° C. | 0.211 | 0.172 |

Dynamic Properties using DMA

| | | |
|---|---|---|
| Tan delta@1 HZ, R.T | 0.1993 | 0.1267 |
| Tan delta@10 HZ, R.T | 0.2261 | 0.1369 |
| Tan delta@1 HZ, 60° C. | 0.1399 | 0.1170 |
| Tan delta@10 HZ, 60° C. | 0.1549 | 0.1229 |

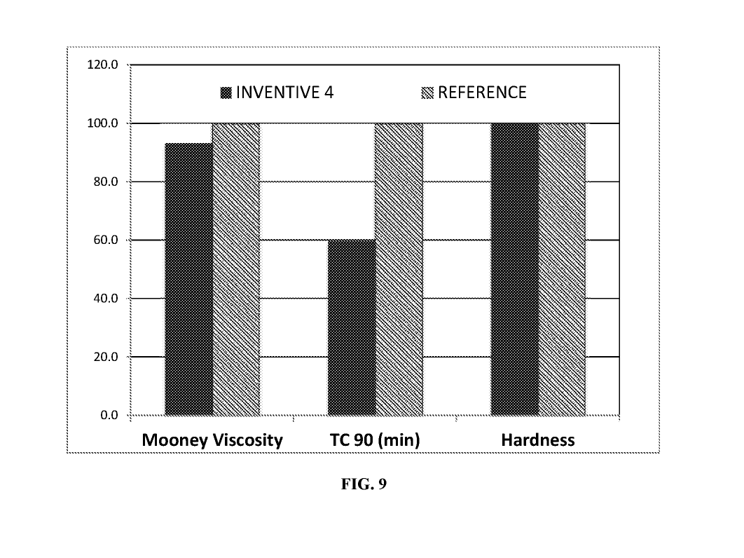

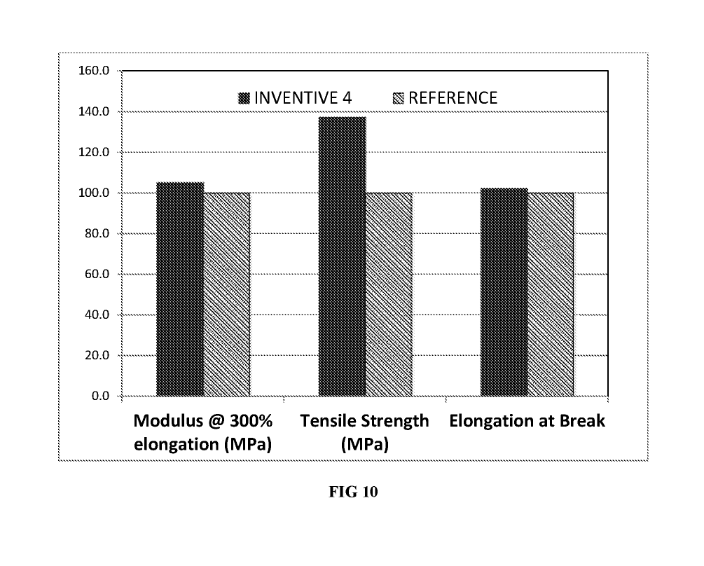

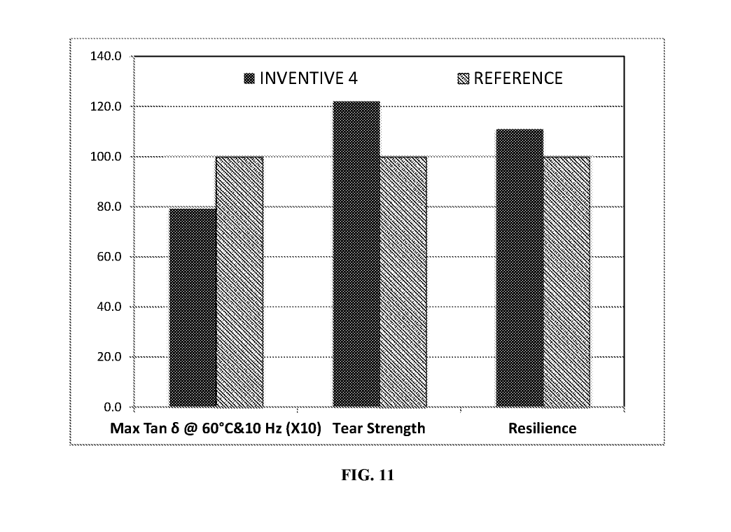

As illustrated in FIG. 9, INVENTIVE masterbatch 4 imparted decreased Mooney viscosity, significantly reduced cure time, and comparable hardness, as compared to a convention reference rubber compound. This sample (i.e., INVENTIVE 4) also imparted increased 300% modulus, increased tensile strength, and comparable elongation at break, as compared to the reference rubber compound, as illustrated in FIG. 10. In addition, INVENTIVE masterbatch 4 resulted in a reduced tan delta @ 60° C. (10 Hz), increased tear strength, and increased Rebound resilience, as illustrated in FIG. 11.

Throughout this application, various publications are referenced. The disclosures of these publications in their entireties are hereby incorporated by reference into this application in order to more fully describe the state of the art to which this application pertains. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publications provided herein can be different from the actual publication dates, which can require independent confirmation.

What is claimed is:

1. A masterbatch composition comprising a rubber material and carbon black, wherein the concentration of carbon black in the masterbatch composition is from about 20 phr to about 80 phr.

2. The masterbatch composition of claim 1, wherein the concentration of carbon black is from about 35 phr to about 75 phr.

3. (canceled)

4. The masterbatch composition of claim 1, wherein the rubber material comprises a latex.

5. (canceled)

6. The masterbatch composition of claim 1, wherein the rubber material comprises a styrene butadiene rubber.

7. (canceled)

8. (canceled)

9. (canceled)

10. The masterbatch composition of claim 1, wherein the carbon black is unpelleted.

11. The masterbatch composition of claim 1, having one or more of the following in-rubber properties when compounded with an elastomer according to ASTM D3192-09, each as compared to a conventional rubber formulation:
a) Mooney Viscosity decreased from about 5% to about 25%;
b) 300% Modulus increased from about 4% to about 40%;
c) Tensile Strength increased from about 20% to about 45%;
d) Tear Strength increased from about 15% to about 30%;
e) Tan delta at 60° (10 Hz) decreased from about 5% to about 35%; or
f) Rebound resilience increased from about 5% to about 15%.

12. (canceled)

13. (canceled)

14. (canceled)

15. The masterbatch composition of claim 1, wherein the carbon black is uniformly or substantially uniformly dispersed in the rubber material.

16. A method for preparing a masterbatch composition, the method comprising:
a) contacting carbon black, water, and a surfactant to form a carbon black slurry;
b) contacting the carbon black slurry with a rubber solution comprising a rubber material;
c) coagulating the rubber solution and carbon black slurry.

17. The method of claim 16, wherein the carbon black slurry has a carbon black concentration of from about 3 wt. % to about 15 wt. %.

18. (canceled)

19. (canceled)

20. (canceled)

21. (canceled)

22. (canceled)

23. (canceled)

24. (canceled)

25. (canceled)

26. The method of claim 16, wherein the carbon black is unpelleted.

27. The method of claim 16, wherein the rubber solution comprises a latex.

28. (canceled)

29. (canceled)

30. The method of claim 16, wherein the rubber solution comprises a styrene butadiene rubber.

31. The method of claim 16, wherein the rubber solution comprises an aqueous solution with from about 30 wt. % to about 80 wt. % of the rubber material.

32. (canceled)

33. (canceled)

34. The method of claim 16, further comprising contacting an antioxidant with either the carbon black slurry and/or the rubber solution.

35. The method of claim 16, wherein coagulating comprises contacting the carbon black slurry and rubber solution with an acid.

36. (canceled)

37. (canceled)

38. (canceled)

39. (canceled)

40. The method of claim 16, wherein coagulating comprises heating the carbon black slurry and rubber solution.

41. (canceled)

42. (canceled)

43. (canceled)

44. The method of claim 16, wherein after coagulating, the resulting coagulant can be sheeted out and dried to a moisture content of less than about 1 wt. %.

45. (canceled)

46. The method of claim 16, wherein the combination of carbon black and surfactant is mixed after the addition of each portion of carbon black and surfactant.

47. (canceled)

48. (canceled)

49. (canceled)

50. (canceled)

51. A rubber compound prepared by the method of claim 16.
